(19) United States
(12) Patent Application Publication
(10) Pub. No.: US 2024/0095495 A1
(43) Pub. Date: Mar. 21, 2024

(54) ATTENTION NEURAL NETWORKS WITH SHORT-TERM MEMORY UNITS

(71) Applicant: DeepMind Technologies Limited, London (GB)

(72) Inventors: Andrea Banino, London (GB); Adrià Puigdomènech Badia, London (GB); Jacob Charles Walker, London (GB); Timothy Anthony Julian Scholtes, London (GB); Jovana Mitrovic, London (GB); Charles Blundell, London (GB)

(21) Appl. No.: 18/275,052

(22) PCT Filed: Feb. 7, 2022
(86) PCT No.: PCT/EP2022/052893

§ 371 Date: Jul. 31, 2023

Related U.S. Application Data
(60) Provisional application No. 63/146,361, filed on Feb. 5, 2021.

(51) Int. Cl. G06N 3/0442; G06N 3/092

(52) U.S. Cl. CPC G06N 3/0442; G06N 3/092

(57) ABSTRACT

A system for controlling an agent interacting with an environment to perform a task. The system includes an action selection neural network configured to generate action selection outputs that are used to select actions to be performed by the agent. The action selection neural network includes an encoder sub network configured to generate encoded representations of the current observations; an attention sub network configured to generate attention sub network outputs with the used of an attention mechanism; a recurrent sub network configured to generate recurrent sub network outputs; and an action selection sub network configured to generate the action selection outputs that are used to select the actions to be performed by the agent in response to the current observations.

### CROSS-REFERENCE TO RELATED APPLICATION

This application claims priority to U.S. Provisional Application No. 63/146,361, filed on Feb. 5, 2021. The disclosure of the prior application is considered part of and is incorporated by reference in the disclosure of this application.

### BACKGROUND

This specification relates to reinforcement learning.

In a reinforcement learning system, an agent interacts with an environment by performing actions that are selected by the reinforcement learning system in response to receiving observations that characterize the current state of the environment.

Some reinforcement learning systems select the action to be performed by the agent in response to receiving a given observation in accordance with an output of a neural network.

Neural networks are machine learning models that employ one or more layers of nonlinear units to predict an output for a received input. Some neural networks are deep neural networks that include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification generally describes a reinforcement learning system that controls an agent interacting with an environment.

The subject matter described in this specification can be implemented in particular embodiments so as to realize one or more of the following advantages.

By incorporating the self-attention mechanism of attention-based neural networks together with the memory mechanism of recurrent neural networks such as long short-term memory (LSTM) neural networks into an action selection neural network used by a reinforcement learning system to select actions to be performed by an agent, the described techniques can provide temporally structured information to the action selection neural network to improve the quality of the action selection outputs, either during training or after training, i.e., at run time. In particular, the described techniques effectively leverage both the self-attention mechanism to extract long range dependencies and the memory mechanism to reason over shorter-term dependencies to integrate information about past interactions of the agent with the environment at multiple different timescales, thereby allowing the action selection neural network to reason over events spanning multiple timescales and to adjust future action selection policies accordingly.

Additionally, the techniques described in this specification include, optionally, the implementation of a trainable gating mechanism to allow the action selection neural network to more effectively combine the information computed by using the attention-based neural network and the recurrent neural network. This effective combination can be particularly advantageous in a complex environment setting because it permits greater flexibility in determining which information should be processed in controlling a robotic agent. Here the term “gating mechanism” means a unit which forms a dataset based on both the input to a neural network and the output of the neural network. A trainable gating mechanism is one in which the dataset is further based on one or more adjustable parameter values. The gating mechanism may, for example, be employed to generate a dataset based on the both the input to the attention sub network and the output of the attention sub network.

The reinforcement learning system described in this specification can thus achieve superior performance to conventional reinforcement learning systems in controlling the agent to perform a task, for example by receiving more cumulative extrinsic reward. The reinforcement learning system described in this specification trains the action selection neural network faster than conventional reinforcement learning systems that do not a utilize self-attention mechanism or a memory mechanism or both. Further, by training the action selection neural network on contrastive learning auxiliary tasks, in addition to training the neural network to maximize cumulative reward, the reinforcement learning system described in this specification can augment the feedback signals received during the training of the action selection neural network to additionally improve training, for example to encourage the learning of representations that aid in obstacle avoidance or trajectory planning. Therefore, the reinforcement learning system described in this specification allows more efficient use of computational resources in training.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example reinforcement learning system.

FIG. 2 is a flow diagram of an example process for controlling an agent.

FIG. 3 is a flow diagram of an example process for determining an update to the parameter values of an attention selection neural network.

FIG. 4 is an example illustration of determining an update to the parameter values of an attention selection neural network.

FIG. 5 shows a quantitative example of the performance gains that can be achieved by using a control neural network system described in this specification.

Like reference numbers and designations in the various drawings indicate like elements.

### DETAILED DESCRIPTION

This specification describes a reinforcement learning system that controls an agent interacting with an environment by, at each of multiple time steps, processing data characterizing the current state of the environment at the time step (i.e., an “observation”) to select an action to be performed by the agent.

At each time step, the state of the environment at the time step depends on the state of the environment at the previous time step and the action performed by the agent at the previous time step.

In some implementations, the environment is a real-world environment and the agent is a mechanical agent interacting with the real-world environment, e.g., a robot or an autonomous or semi-autonomous land, air, or sea vehicle navigating through the environment.

In these implementations, the observations may include, e.g., one or more of: images, object position data, and sensor data to capture observations as the agent interacts with the environment, for example sensor data from an image, distance, or position sensor or from an actuator.

For example in the case of a robot, the observations may include data characterizing the current state of the robot, e.g., one or more of: joint position, joint velocity, joint force, torque or acceleration, e.g., gravity-compensated torque feedback, and global or relative pose of an item held by the robot.

In the case of a robot or other mechanical agent or vehicle the observations may similarly include one or more of the position, linear or angular velocity, force, torque or acceleration, and global or relative pose of one or more parts of the agent. The observations may be defined in 1, 2 or 3 dimensions, and may be absolute and/or relative observations.

The observations may also include, for example, sensed electronic signals such as motor current or a temperature signal; and/or image or video data for example from a camera or a LIDAR sensor, e.g., data from sensors of the agent or data from sensors that are located separately from the agent in the environment.

In these implementations, the actions may be control inputs to control the robot, e.g., torques for the joints of the robot or higher-level control commands, or the autonomous or semi-autonomous land, air, sea vehicle, e.g., torques to the control surface or other control elements of the vehicle or higher-level control commands.

In other words, the actions can include for example, position, velocity, or force/torque/acceleration data for one or more joints of a robot or parts of another mechanical agent. Action data may additionally or alternatively include electronic control data such as motor control data, or more generally data for controlling one or more electronic devices within the environment the control of which has an effect on the observed state of the environment. For example in the case of an autonomous or semi-autonomous land or air or sea vehicle the actions may include actions to control navigation e.g. steering, and movement e.g., braking and/or acceleration of the vehicle.

In some other applications the agent may control actions in a real-world environment including items of equipment, for example in a data center, in a power/water distribution system, or in a manufacturing plant or service facility. The observations may then relate to operation of the plant or facility. For example the observations may include observations of power or water usage by equipment, or observations of power generation or distribution control, or observations of usage of a resource or of waste production. The actions may include actions controlling or imposing operating conditions on items of equipment of the plant/facility, and/or actions that result in changes to settings in the operation of the plant/facility e.g. to adjust or turn on/off components of the plant/facility.

In the case of an electronic agent the observations may include data from one or more sensors monitoring part of a plant or service facility such as current, voltage, power, temperature and other sensors and/or electronic signals representing the functioning of electronic and/or mechanical items of equipment. For example the real-world environment may be a manufacturing plant or service facility, the observations may relate to operation of the plant or facility, for example to resource usage such as power consumption, and the agent may control actions or operations in the plant/facility, for example to reduce resource usage. In some other implementations the real-world environment may be a renewal energy plant, the observations may relate to operation of the plant, for example to maximize present or future planned electrical power generation, and the agent may control actions or operations in the plant to achieve this.

As another example, the environment may be a chemical synthesis or protein folding environment such that each state is a respective state of a protein chain or of one or more intermediates or precursor chemicals and the agent is a computer system for determining how to fold the protein chain or synthesize the chemical. In this example, the actions are possible folding actions for folding the protein chain or actions for assembling precursor chemicals/intermediates and the result to be achieved may include, e.g., folding the protein so that the protein is stable and so that it achieves a particular biological function or providing a valid synthetic route for the chemical. As another example, the agent may be a mechanical agent that performs or controls the protein folding actions or chemical synthesis steps selected by the system automatically without human interaction. The observations may comprise direct or indirect observations of a state of the protein or chemical/intermediates/precursors and/or may be derived from simulation.

In some implementations the environment may be a simulated environment and the agent may be implemented as one or more computers interacting with the simulated environment.

The simulated environment may be a motion simulation environment, e.g., a driving simulation or a flight simulation, and the agent may be a simulated vehicle navigating through the motion simulation. In these implementations, the actions may be control inputs to control the simulated user or simulated vehicle.

In some implementations, the simulated environment may be a simulation of a particular real-world environment. For example, the system may be used to select actions in the simulated environment during training or evaluation of the control neural network and, after training or evaluation or both are complete, may be deployed for controlling a real-world agent in the real-world environment that is simulated by the simulated environment. This can avoid unnecessary wear and tear on and damage to the real-world environment or real-world agent and can allow the control neural network to be trained and evaluated on situations that occur rarely or are difficult to re-create in the real-world environment.

Generally, in the case of a simulated environment, the observations may include simulated versions of one or more of the previously described observations or types of observations and the actions may include simulated versions of one or more of the previously described actions or types of actions.

Optionally, in any of the above implementations, the observation at any given time step may include data from a previous time step that may be beneficial in characterizing the environment, e.g., the action performed at the previous time step, the reward received at the previous time step, and so on.

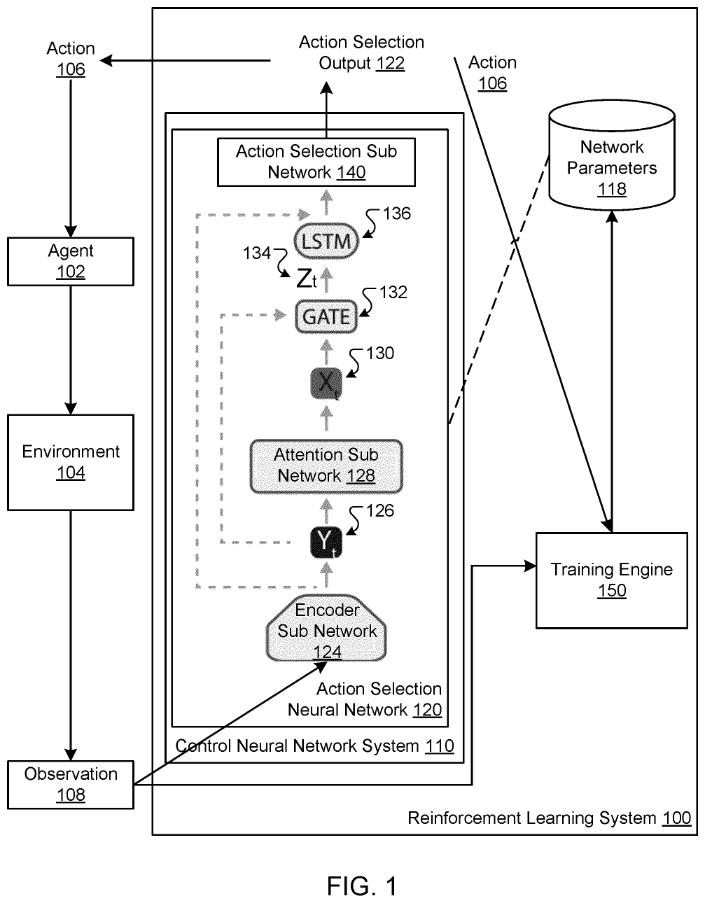

FIG. 1 shows an example reinforcement learning system 100. The reinforcement learning system 100 is an example of a system implemented as computer programs on one or more computers in one or more locations in which the systems, components, and techniques described below are implemented.

The system 100 controls an agent 102 interacting with an environment 104 by selecting actions 106 to be performed by the agent 102 and then causing the agent 102 to perform the selected actions 106, such as by transmitting control data to the agent 102 which instructs the agent 102 to perform the action 102. In some cases, the reinforcement learning system 100 may be mounted on, or be a component of, the agent 102, and the control data is transmitted to actuator(s) of the agent.

Performance of the selected actions 106 by the agent 102 generally causes the environment 104 to transition into successive new states. By repeatedly causing the agent 102 to act in the environment 104, the system 100 can control the agent 102 to complete a specified task.

The system 100 includes a control neural network system 110, and one or more memories storing a set of model parameters 118 (“network parameters”) of the neural networks that are included in the control neural network system 110.

At a high level, the control neural network system 110 is configured to process, at each of multiple time steps, an input that includes the current observation 108 characterizing the current state of the environment 104 in accordance with the model parameters 118 to generate an action selection output 122 that can be used to select a current action 106 to be performed by the agent 102 in response to the current observation 108.

The control neural network system 110 includes an action selection neural network 120. The action selection neural network 120 is implemented with a neural network architecture that improves the quality of the action selection outputs 122 by enabling the system to detect and react to events that occur at different timescales. Specifically, the action selection neural network 120 includes an encoder sub network 124, an attention sub network 128, a gating subnetwork 132 (preferably), a recurrent sub network 136, and an action selection sub network 140. Each sub network can be implemented as a group of one or more neural network layers in the action selection neural network 120.

At each of multiple time steps, the encoder sub network 124 is configured to receive an encoder sub network input that includes a current observation 108 characterizing a current state of the environment 104 and to process the encoder sub network input in accordance with trained parameter values of the encoder sub network to generate an encoded representation (“Yₜ”) 126 of the current observation 108. The encoded representation 126 can be in form of an ordered collection of numerical values, e.g., a vector or matrix of numerical values. For example, the encoded representation 126, which is subsequently fed as input to the attention sub network 128, can be an input vector having a respective input value at each of multiple input positions in an input order. In some implementations, the encoded representation 126 has the same dimensionality as the observation 108, and in some other implementations the encoded representation 126 has a smaller dimensionality than the observation 108, for reasons of computational efficiency. In some implementations, in addition to providing the encoded representation 126 as input to the attention sub network 128, the system also stores the encoded representation 126 generated at a given time step into a memory buffer or a lookup table so that the encoded representation 126 can be used later, e.g., at a future time step that is subsequent to the given time step.

When the observations are images, the encoder sub network 124 can be a convolutional sub network, e.g., a convolutional neural network with residual blocks, that is configured to process the observation for a time step. In some cases, e.g. when the observations include lower-dimensional data, the encoder sub network 124 can additionally or instead include one or more fully-connected neural network layers.

The attention sub network 128 is a network that includes one or more attention neural network layers. Each attention layer operates on a respective input sequence that includes a respective input vector at each of one or more positions (e.g. a plurality of concatenated input vectors). At each of multiple time steps, the attention sub network 128 is configured to receive an attention sub network input that includes the encoded representation 126 of the current observation 108 and the encoded representations of one or more previous observations, and to process the attention sub network input in accordance with trained parameter values of the attention sub network to generate an attention sub network output (“Xₜ”) 130 at least in part by applying an attention mechanism to the respective encoded representations of the current observation and one or more previous observations. That is, the attention sub network output (“Xₜ”) 130 is an output determined or otherwise derived from an updated (i.e., “attended”) representation of the encoded representations that is generated by using the one or more attention neural network layers.

In particular, in addition to the encoded representation 126 of the current observation 108, the attention sub network input also includes the encoded representations of one or more previous observations characterizing the one or more previous states of the environment that immediately precede the current state of the environment 108. Each encoded representation of a previous observation can be in the form of a respective input vector that includes a respective input value at each of multiple input positions in an input order. Thus, the attention sub network input can be a concatenated input vector that is made up of multiple individual input vectors, each corresponding to a respective encoded representation of an observation of a different previous state of the environment 108 up to (and including) the current state.

Generally, the attention layers within the attention sub network 128 can be arranged in any of a variety of configurations. Examples of the configurations of the attention layers the specifics of the other components of attention sub network are described in more detail in Vaswani, et al., Attention Is All You Need, arXiv:1706.03762, and in Parisotto, et al., Stabilizing transformers for reinforcement learning, arXiv:1910.06764, the entire contents of which are hereby incorporated by reference herein in their entirety. For example, the attention mechanism applied by the attention layers within the attention sub network 128 can be a self-attention mechanism, e.g., a multi-head self-attention mechanism.

Generally, an attention mechanism maps a query and a set of key-value pairs to an output, where the query, keys, and values are all vectors derived from an input to the attention mechanism based on respective matrices. The output is computed as a weighted sum of the values, where the weight assigned to each value is computed by a compatibility function e.g. a dot product or scaled dot product, of the query with the corresponding key. In general an attention mechanism determines a relationship between two sequences; a self-attention mechanism is configured to relate different positions in the same sequence to determine a transformed version of the sequence as an output. The attention layer input may comprise a vector for each element of the input sequence. These vectors provide an input to the self-attention mechanism and are used by the self-attention mechanism to determine a new representation of the same sequence for the attention layer output, which similarly comprises a vector for each element of the input sequence. An output of the self-attention mechanism may be used as the attention layer output.

In some implementations the attention mechanism is configured to apply each of a query transformation e.g. defined by a matrix W^{Q}, a key transformation e.g. defined by a matrix W^{K}, and a value transformation e.g. defined by a matrix W^{V}, to the attention layer input for each input vector X of the input sequence to derive a respective query vector Q=XW^{Q}, key vector K=XW^{K}, and value vector V=XW^{V}, which are used determine an attended sequence for the output. For example the attention mechanism may be a dot product attention mechanism applied by applying each query vector to each key vector to determine respective weights for each value vector, then combining the value vectors using the respective weights to determine the attention layer output for each element of the input sequence. The attention layer output may be scaled by a scaling factor e.g. by the square root of the dimensions of the queries and keys, to implement scaled dot product attention. Thus, for example, an output of the attention mechanism may be determined as

$$\\ softmax ( \frac{{QK}^{T}}{\sqrt{d}} ) V$$

where d is a dimension of the key (and value) vector. In another implementation the attention mechanism be comprise an “additive attention” mechanism that computes the compatibility function using a feed-forward network with a hidden layer.

The attention mechanism may implement multi-head attention, that is it may apply multiple different attention mechanisms in parallel. The outputs of these may then be combined, e.g. concatenated, with a learned linear transformation applied to reduce to the original dimensionality if necessary.

An attention, or self-attention, neural network layer is a neural network layer that includes an attention, or self-attention, mechanism (that operates over the attention layer input to generate the attention layer output). The attention sub-network 128 may comprise a single attention layer, or alternatively a sequence of attention layers, of which each attention layer but the first receives as an input an output from the preceding attention layer of the sequence.

In addition, in this example, the self-attention mechanism can be masked, so that any given position in the input sequence does not attend over any positions after the given position in the input sequence. For example, for a subsequent position that is after the given position in the input sequence, the attention weight for the subsequent position is set to zero.

The recurrent sub network 136 is a network that includes one or more recurrent neural network layers, e.g., one or more long short-term memory (LSTM) layers, one or more gated recurrent unit (GRU) layers, one or more vanilla recurrent neural network (RNN) layers, and so on. The recurrent sub network 136 is configured to receive and process, at each of multiple time steps, a recurrent sub network input in accordance with trained parameter values of the recurrent sub network to update a current hidden state of the recurrent sub network that corresponds to the time step and to generate a recurrent sub network output.

In particular, the recurrent sub network input is derived from the attention sub network output 130. In some implementations, the action selection neural network 120 can directly provide the attention sub network output 130 as input to the recurrent sub network 136. Alternatively, in some implementations, the action selection neural network 120 can make use of a gating subnetwork 132 to combine the respective outputs 126 and 130 of the encoder sub network 124 and the attention sub network 128. Thus, the recurrent sub network input can be an output (“Zₜ”) 134 of a gating subnetwork 132 of the action selection neural network 120.

In some of these implementations, the gating mechanism implemented by the gating subnetwork 132 is a fixed, summation (or a concatenation) mechanism, and the gating subnetwork can include a summation (or concatenation) layer that is configured to receive the encoded representation 126 of the current observation and the attention sub network output 130, and to generate an output based on them. For example, it may compute, along a predetermined dimension of the received layer inputs, a summation (or concatenation) of i) the encoded representation 126 of the current observation and ii) the attention sub network output 130.

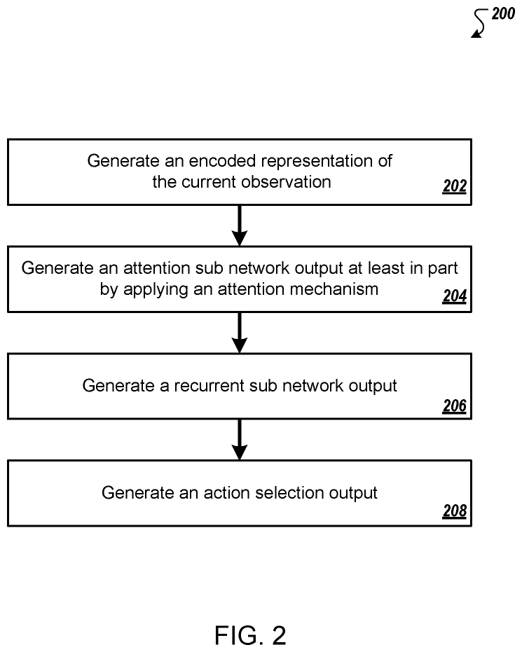

In others of these implementations, the gating mechanism implemented by the gating subnetwork 132 is a learnt gating mechanism that facilitates more effective combination the information contained within or otherwise derivable from the respective outputs 126 and 130 of the encoder sub network 124 and the attention sub network 128. In these implementations, the gating subnetwork 132 can include a gated recurrent unit (GRU) layer that is configured, i.e., through training, to apply a learned, GRU gating mechanism in accordance with trained parameter values of the GRU layer to i) the encoded representation 126 of the current observation and ii) the attention sub network output 130 to generate a gated output, i.e., the gating subnetwork output 134, which is then fed as input into the recurrent sub network 136. Combining the encoded representation 126 and the attention sub network output 130 using the GRU gating mechanism will be described further below with reference to FIG. 2. In some implementations, a skip (“residual”) connection can be arranged between the encoder sub network 124 and the gating subnetwork 132, and the gating subnetwork 132 can be configured to receive the encoded representation 126 through the skip connection, in addition to directly receiving the attention sub network output 130 from the attention sub network 128.

The action selection sub network 140 is configured to receive, at each of multiple time steps, an action selection sub network input and to process the action selection sub network input in accordance with trained parameter values of the action selection sub network 140 to generate the action selection output 122. The action selection sub network input includes the recurrent sub network output and, in some implementations, the encoded representation 126 generated by the encoder sub network 124. In the implementations where the action selection sub network input also includes the encoded representation 126, a skip connection can be arranged between the encoder sub network 124 and the action selection sub network 140, and the action selection sub network 140 can be configured to receive the encoded representation 126 through the skip connection, in addition to directly receiving the recurrent sub network output from the recurrent sub network 136.

The system 100 then uses the action selection output to select the action to be performed by the agent at the current time step. A few examples of using the action selection output to select the action to be performed by the agent are described next.

In one example, the action selection output 122 may include a respective numerical probability value for each action in a set of possible actions that can be performed by the agent. The system can select the action to be performed by the agent, e.g., by sampling an action in accordance with the probability values for the actions, or by selecting the action with the highest probability value.

In another example, the action selection output 122 may directly define the action to be performed by the agent, e.g., by defining the values of torques that should be applied to the joints of a robotic agent.

In another example, the action selection output 122 may include a respective Q value for each action in the set of possible actions that can be performed by the agent. The system can process the Q values (e.g., using a soft-max function) to generate a respective probability value for each possible action, which can be used to select the action to be performed by the agent (as described earlier). The system could also select the action with the highest Q value as the action to be performed by the agent.

The Q value for an action is an estimate of a “return” that would result from the agent performing the action in response to the current observation and thereafter selecting future actions performed by the agent in accordance with current values of the policy neural network parameters.

A return refers to a cumulative measure of “rewards” received by the agent, for example, a time-discounted sum of rewards. The agent can receive a respective reward at each time step, where the reward is specified by a scalar numerical value and characterizes, e.g., a progress of the agent towards completing an assigned task.

In some cases, the system can select the action to be performed by the agent in accordance with an exploration policy. For example, the exploration policy may be an ϵ-greedy exploration policy, where the system selects the action to be performed by the agent in accordance with the action selection output 122 with probability 1-ϵ, and randomly selects the action with probability E. In this example, E is a scalar value between 0 and 1.

Controlling an agent using the control neural network system 110 will be described in more detail below with reference to FIG. 2.

To more effectively control the agent 102 to interact with the environment 104, the reinforcement learning system 100 can use a training engine 150 to train the action selection neural network 120 to determine trained values of the parameters 118 of the action selection neural network 120.

The training engine 150 is configured to train the action selection neural network 120 by repeatedly updating the model parameters 118, i.e., the parameter values of the encoder sub network 124, the attention sub network 128, the gating subnetwork 132, the recurrent sub network 136, and the action selection sub network 140, based on the interactions of the agent 102 (or another agent) with the environment 108 (or another instance of the environment).

In particular, the training engine 150 trains the action selection neural network 120 through reinforcement learning and, optionally, also through contrastive representation learning. Contrastive representation learning means teaching a neural network component of the action selection neural network—in particular the attention sub network 128—to generate outputs upon receiving respective inputs, such that the action selection neural network, upon successively receiving a pair of similar inputs (e.g. as measured by a similarity measure; for example, a distance measure such as Euclidean distance) generates respective outputs which are more similar to each other than the respective outputs the action selection network generates from inputs which are further apart than the pair of similar inputs. In an example given below, the contrastive representation learning is based training the action sub network 128 to generate, upon receiving an input which is a masked form of data generated by the encoder sub network 124 at a given time step, an output which reconstructs the same data generated by the encoder sub network 124, and/or data generated by the encoder sub network 124 at another time step.

In reinforcement learning the action selection neural network 120 is trained based on the agent's interaction with the environment in order to optimize an appropriated reinforcement learning objective function. The architecture of the action selection neural network 120 is agnostic to the choice of the exact RL training algorithm, and thus the RL training can be either on-policy (e.g., one of the RL algorithms described in more detail at Song, et al., V-mpo: On-policy maximum a posteriori policy optimization for discrete and continuous control, arXiv:1909.12238), or off-policy (e.g., one of the RL algorithms described in more detail at Kapturowski, et al., Recurrent experience replay in distributed reinforcement learning. In International conference on learning representations, 2018.)

As part of this RL training process, the observations 108 received by the reinforcement learning system 100 during the interaction are encoded into encoded representations from which the action selection outputs 122 are generated. Learning to generate informative encoded representations is thus an important factor for successful RL training. To do so, the training engine 150 evaluates a time domain contrastive learning objective and uses it as a proxy supervision signal for masked prediction training of the attention sub network 128, i.e., for training the attention sub network 128 to predict the masked portion of the attention sub network input. Such a signal aims to learn self-attention-consistent representations that contain the appropriate information for the action selection sub network 140 to effectively incorporate information previously observed (or extracted) by the attention sub network 128.

In some implementations, by making use of the contrastive representation learning techniques to assist in determining parameter value updates, the training engine 150 improves efficiency of the training process, e.g., in terms of the amount of computational resources or wall-clock time consumed by the training process required to train the action selection neural network 120 to achieve or exceed the state-of-the-art performance in controlling the agent to perform a given task.

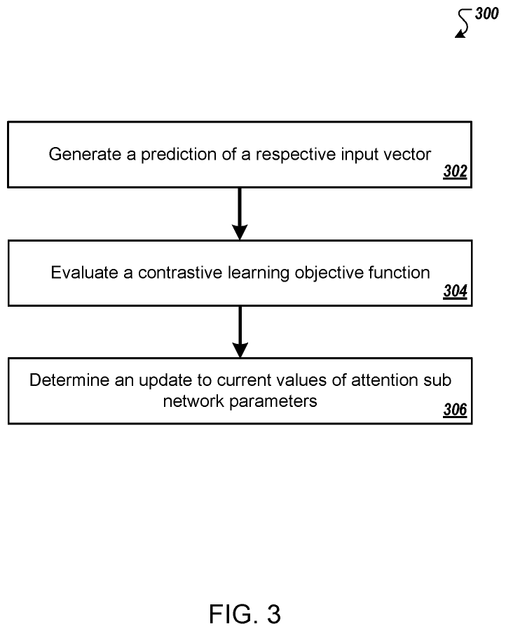

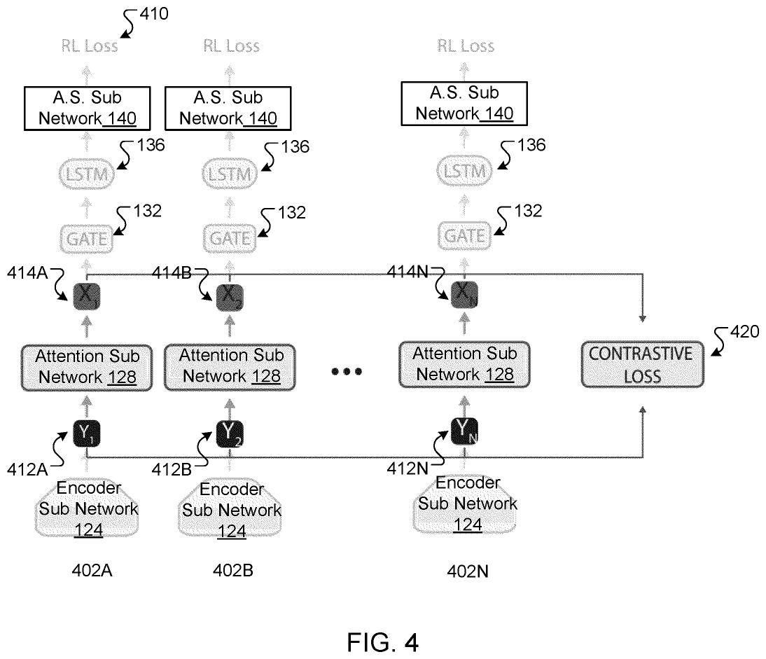

Training the action selection neural network 120 will be described in more detail below with reference to FIGS. 3 and 4.

FIG. 2 is a flow diagram of an example process 200 for controlling an agent. For convenience, the process 200 will be described as being performed by a system of one or more computers located in one or more locations. For example, a reinforcement learning system, e.g., the reinforcement learning system 100 of FIG. 1, appropriately programmed, can perform the process 200.

In general the system can repeatedly perform the process 200 at each of multiple time steps to select a respective action (referred to as the “current” action below) to be performed by the agent at a respective state of the environment (referred to as the “current” state below) that corresponds to the time step (referred to as the “current” time step below).

The system receives a current observation characterizing a current state of the environment at a current time step and generates an encoded representation of the current observation by using an encoder sub network (step 202). For example, the current observation can include an image, a video frame, an audio data segment, a sentence in a natural language, or the like. In some of these examples, the observation can also include information derived from the previous time step, e.g., the previous action performed, a reward received at the previous time step, or both. The encoded representation of an observation can be represented as an ordered collection of numerical values, e.g., a vector or matrix of numerical values.

The system processes an attention sub network input that includes the encoded representation of the current observation and the encoded representations of one or more previous observations by using an attention sub network to generate an attention sub network output (step 204). The one or more previous observations characterize one or more previous states of the environment that precede the current state of the environment, and thus the encoded representations of the one or more previous observations can be the encoded representations generated by using the encoder sub network at one or more time steps that precede the current time step.

The attention sub network can be a neural network that includes one or more attention neural network layers and that is configured to generate the attention sub network output at least in part by applying an attention mechanism, e.g., a self-attention mechanism, over the encoded representation of the current observation and the encoded representations of the one or more previous observations characterizing the one or more previous states of the environment. This use of the attention mechanism facilitates connection of long-range data dependencies, e.g., across respective observations of a lengthy sequence of different states of the environment.

In more detail, the attention sub network input can include a concatenated input vector that is made up of multiple individual input vectors corresponding to different encoded representations that each have a respective input value at each of multiple input positions in an input order. To generate the attention sub network output, each attention layer included in the attention sub network can be configured to receive an attention layer input (which may be similarly in the format of a vector) for each of one or more layer input positions and, for each particular layer input position in a layer input order, apply the attention mechanism over the attention layer inputs at the layer input positions using one or more queries derived from the attention layer input at the particular layer input position to generate a respective attention layer output for the particular layer input position.

The system generates a combination of i) the encoded representation of the current observation and ii) the attention sub network output, and subsequently provides the combination as input to the recurrent sub network. To generate the combination, the system can make use of a gating subnetwork that is configured to apply a gating mechanism to i) the encoded representation of the current observation and ii) the attention sub network output to generate the recurrent sub network input. For example, the gating subnetwork can include a gated recurrent unit (GRU) layer that is configurable to apply a less complex GRU gating mechanism than a LSTM layer, by making use of a smaller number of layer parameters. As another example, the gating subnetwork could also compute a summation or concatenation of i) the encoded representation of the current observation and ii) the attention sub network output.

Specifically, in the prior example, the GRU layer is a recurrent neural network layer that performs similarly to a Long Short-Term Memory (LSTM) layer with a forget gate but has fewer parameters than LSTM, as it lacks an output gate. In some implementations, this gating mechanism can be adapted as an update of a GRU layer which is unrolled over the depth of the action selection neural network instead of being unrolled over time. That means, while the GRU layer is a recurrent neural network (RNN) layer, the gating mechanism can use the same formula that GRU layer uses to update its hidden state over time to instead generate an “updated” combination of the inputs received at the gating subnetwork of the action selection neural network.

In these implementations, the GRU layer applies a non-linear function such as a sigmoid activation σ( ) to a weighted combination of the received layer inputs, i.e., the encoded representation Yₜ and the attention sub network output Xₜ, to compute the reset gate r and update gate z, respectively:

r=σ(Wᵣ^{(l)}y+Uᵣ^{(l)}x),

z=σ(W_{z}^{(l)}y+U_{z}^{(l)}x−b_{g}^{(l)}),

and applies a non-linear function such as a tanh activation tanh( ) to a weighted combination of the encoded representation Yₜ and an element-wise product between the reset gate r and the attention sub network output Xₜ to generate an updated hidden state it:

ĥ=tanh(W_{g}^{(l)}y+U_{g}^{(l)}(r⊙x)),

where Wᵣ^{(l)}, Uᵣ^{(l)}, W_{z}^{(l)}, U_{z}^{(l)}, b_{g}^{(l)}, W_{g}^{(l)}, and U_{g}^{(l)} are weights (or bias) determined from the values of the GRU layer parameters, and ⊙ denotes element-wise multiplication. The GRU layer then generates a gated output g^{(l)}(x, y) (which can be used as the recurrent sub network input) as follows:

g^{(l)}(x,y)=(1−z)⊙x+z⊙ĥ.

The system processes the recurrent sub network input by using a recurrent sub network to generate a recurrent sub network output (step 206). The recurrent sub network can be configured to receive the recurrent sub network input, and update a current hidden state of recurrent sub network by processing the received input, i.e., to modify the current hidden state of the recurrent sub network that has been generated by processing the previous recurrent sub network inputs by processing the current received recurrent sub network input. The updated hidden state of the recurrent sub network after processing the recurrent sub network input will be referred to below as the hidden state that corresponds to the current time step. Once the updated hidden state of that corresponds to the current time step has been generated, the system can use the updated hidden state of the recurrent sub network to generate the recurrent sub network output.

For example, the recurrent sub network can be a recurrent neural network that includes one or more long short-term memory (LSTM) layers. Due to their sequential nature, LSTM layers are capable of effectively capturing short-range dependencies, e.g., across consecutive observations of recent states of the environment.

The system processes an action selection sub network input that includes the recurrent sub network output by using an action selection sub network to generate an action selection output that is used to select an action to be performed by the agent in response to the current observation (step 208). In some implementations, the action selection sub network input also includes the encoded representation. In these implementations, to generate the action selection sub network input, the system can compute a concatenation of i) the recurrent sub network output and ii) the encoded representation generated by the encoder sub network at the current time step.

The system can then cause the agent to perform the selected action, i.e., by instructing the agent to perform the action or passing a control signal to a control system for the agent.

As described above, the components of the system can be trained through reinforcement learning in combination with contrastive representation learning. In some implementations, the system maintains a replay buffer to assist in the training. The replay buffer stores multiple transitions generated as a result of the agent interacting with the environment. Each transition represents information about an interaction of the agent with the environment.

In these implementations, each transition is an experience tuple that includes: i) a current observation characterizing the current state of the environment at one time; ii) a current action performed by the agent in response to the current observation; iii) a next observation characterizing the next state of the environment after the agent performs the current action, i.e., a state that the environment transitioned into as a result of the agent performing the current action; and iv) a reward received in response to the agent performing the current action.

Briefly, in these implementations, the RL training can involve iteratively sampling a batch of one or more transitions from the replay buffer and then training the action selection neural network on the sampled transitions by using an appropriate reinforcement learning algorithm. During each RL training iteration, the system can process a current observation included in each sampled transition using the action selection neural network in accordance current parameter values of the action selection neural network to generate an action selection output; determine a reinforcement learning loss based on the action selection output; and then determine, based on computing a gradient of the reinforcement learning loss with respect to the action selection neural network parameters, an update to current values of the action selection network parameters.

FIG. 4 is an example illustration of determining an update to the parameter values of an attention selection neural network. As illustrated, the system can determine a respective reinforcement learning loss, e.g., RL loss 410A, for the action selection output generated at each time step, e.g., time step 402A.

Contrastive representation learning, which can be used to assist the RL training to improve training data efficiency, is described further below.

FIG. 3 is a flow diagram of an example process 300 for determining an update to the parameter values of an attention selection neural network. For convenience, the process 300 will be described as being performed by a system of one or more computers located in one or more locations. For example, a reinforcement learning system, e.g., the reinforcement learning system 100 of FIG. 1, appropriately programmed, can perform the process 300.

In particular, the system can repeatedly perform the process 300 to train the encoder and attention sub networks of the action selection neural network to generate high quality (e.g., informative, predictive, or both) encoded representations and attention sub network outputs, respectively, that facilitate the generation of high quality action selection outputs which in turn results in effective control of the agent in performing a given task.

The system can perform one iteration of process 300 on every batch of one or more transitions sampled from the replay buffer. At the beginning of each iteration, the system can generate an encoded representation of the current observation included in each sampled transition by processing the current observation using the encoder sub network in accordance with current parameter values of the encoder sub network. Unlike at inference time where the encoded representation is directly fed as input to the attention sub network, however, the system generates a masked encoded representation from the encoded representation and subsequently provides the masked encoded representation as input to the attention sub network.

As described above, the encoded representation of the current observation can be in the form of an input vector having a respective input value at each of a plurality of input positions in an input order. By contrast, the masked encoded representation masks the respective input value at each of one or more of the plurality of input positions in the input order, i.e., includes a fixed value (e.g., negative infinity, positive infinity, or another predetermined mask value) in place of the original input value at each of the one or more input positions.

To generate the masked encoded representation (referred to as the “masked input vector” below), the system selects, from the encoded representation, one or more of the plurality of input positions in the input order; and applies a mask to the respective input value at each of the selected one or more of the plurality of input positions in the input order, i.e., replaces the respective input value with the fixed value at each of the selected input position. For example, the selection may be performed through random sampling, and for each encoded representation a fixed amount (e.g., 10%, 15%, or 20%) of input values may be masked.

The system processes, using the attention sub network and in accordance with current parameter values of the attention sub network, a masked input vector that masks the respective input value at each of one or more of the plurality of input positions in the input order to generate a prediction of the respective input value at each of the one or more of the plurality of input positions in the input order (step 302). That is, during contrastive learning training, the attention sub network is trained to perform an auxiliary task of reconstructing an input vector from a masked version of it.

The system evaluates a contrastive learning objective function (step 304). The contrastive learning objective function measures a contrastive learning loss (e.g., contrastive loss 420 of FIG. 4) of the attention sub network in predicting the masked input values from processing the masked input vector.

Specifically, for each of the one or more of the plurality of input positions in the input order: the contrastive learning objective function may measure a first difference between i) the prediction of the respective input value and ii) the respective input value in the input vector that corresponds to the encoded representation of the current observation. The first difference may be referred to as a difference evaluated with respect to a “positive example.” As illustrated in the example of FIG. 4, at a given time step 402A, the system can determine a respective difference for each input position between i) the attention sub network training output (“X₁”) 414A that includes the prediction of the respective input value at the input position and ii) the masked input vector that masks the respective input value originally included in the encoded representation (“Y₁”) 412A of the observation that corresponds to the given time step 402A.

The contrastive learning objective function may also measure a second difference between i) the prediction of the respective input value and ii) a respective input value in another input vector that corresponds to an encoded representation of an augmented current observation. The second difference may be referred to as a difference evaluated with respect to a “negative example.” Additionally or alternatively, the second difference can be a difference between i) the prediction of the respective input value and ii) the prediction of the respective input value in the other input vector that is generated by the attention sub network from a masked input vector that corresponds to the augmented current observation. That is, the second difference can be a difference evaluated with respect to the attention sub network training output generated for the augmented current observation. For example, the first and second differences can be evaluated in terms of a Kullback-Leibler divergence.

In particular, contrastive representation learning typically makes use of data augmentation techniques to create groupings of data that can be compared to generate meaningful training signals.

In some implementations, the system can rely on the sequential nature of the input data, and the augmented current observation can be a future observation that characterizes a future state of the environment that is after the current state. Additionally or alternatively, the augmented current observation can be a history observation that characterizes a past state of the environment that precedes the current state.

As illustrated in the example of FIG. 4, at a given time step 402A, the system can determine a respective difference for each input position between i) the attention sub network training output (“X₁”) 414A that includes the prediction of the respective input value at the input position and ii) a respective input value in another input vector that corresponds to an encoded representation 412B of the future observation received at the future time step 402B. Additionally or alternatively, the system can determine a respective difference for each input position between i) the attention sub network training output (“X₁”) 414A that includes the prediction of the respective input value at the input position and ii) the attention sub network training output (“X₂”) 414B that includes the prediction of the respective input value in the other input vector that is generated by the attention sub network from the masked input vector that corresponds to the future time step 402B. Specifically, in these examples, the respective input value in the other input vector can have same input position within the other input vector as the respective input value in the input vector that corresponds to the sampled transition.

In some other implementations, the system can instead rely on visual representation-based augmentation techniques, and the augmented current observation can for example be a geometrically transformed or color space-transformed representation of the current observation.

The system determines, based on computing a gradient of the contrastive learning loss with respect to the attention sub network parameters, an update to the current parameter values of the attention sub network (step 306). In addition, the system determines, through backpropagation, an update to the current parameters values of the encoder sub network.

In some implementations, the system then proceeds to update the current parameter values based on the gradient of the contrastive learning loss by using a conventional optimizer, e.g., stochastic gradient descent, RIVISprop, or Adam optimizer, including Adam with weight decay (“AdamW”) optimizer. Alternatively, the system only proceeds to update the current parameter values once the steps 302-306 have been performed for an entire batch of sampled transitions. In other words, the system combines, e.g., by computing a weighted or unweighted average of, respective gradients that are determined during the fixed number of iterations of the steps 302-306 and proceeds to update the current parameter values based on the combined gradient.

The system can repeatedly perform the steps 302-306 until a contrastive learning training termination criterion is satisfied, e.g., after the steps 302-306 have been performed a predetermined number of times or after the gradient of the contrastive learning objective function has converged to a specified value.

In some implementations, the system can jointly optimize the reinforcement learning loss together with the contrastive learning loss. Thus, in these implementations, the system combines, e.g., by computing a weighed sum of, the reinforcement learning loss and the contrastive learning loss, and then proceeds to update the current parameter values based on the combined loss. In these implementations, the steps 302-306 can be repeatedly performed until the RL training of the system is completed, e.g., after the gradient of the reinforcement learning objective function has converged to a specified value.

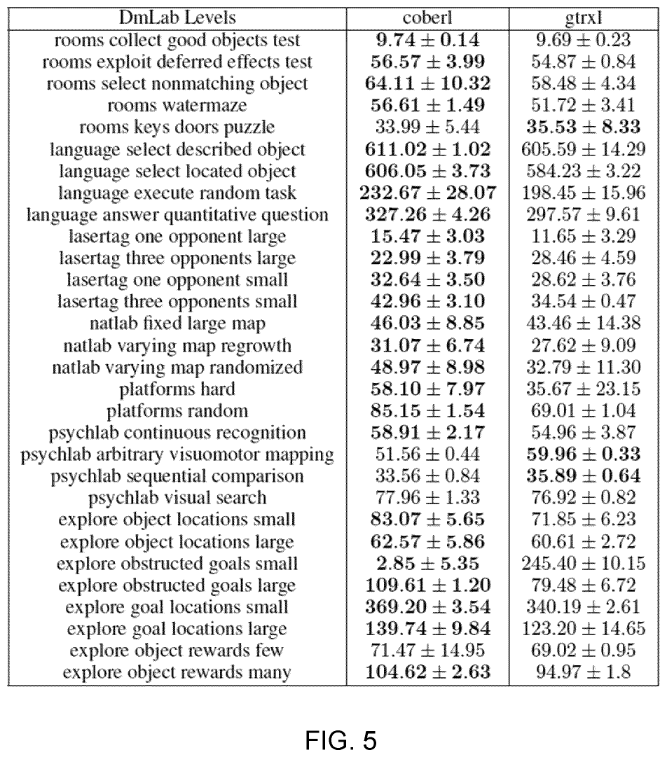

FIG. 5 shows a quantitative example of the performance gains that can be achieved by using a control neural network system described in this specification. Specifically, FIG. 5 shows a list of scores (where higher scores indicate greater rewards) received by an agent controlled using the control neural network system 110 of FIG. 1 on a range of DeepMind Lab tasks. As a platform designed for research and development of general artificial intelligence and machine learning systems, DeepMind Lab (https://arxiv.org/abs/1612.03801) can be used to study how autonomous artificial agents may learn complex tasks in large, partially observed, and visually diverse environments. It can be appreciated that, as shown, the “cober1” agent (corresponding to an agent controlled using the control neural network system described in this specification) generally outperforms the “gtrx1” agent (corresponding to an agent controlled using an existing control system—the “Gated Transformer XL” system described in Parisotto, et al., Stabilizing transformers for reinforcement learning, arXiv:1910.06764—that uses an attention mechanism only) by a decent margin on a majority of the tasks.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A system for controlling an agent interacting with an environment to perform a task, the system comprising one or more computers and one or more storage devices storing instructions that, when executed by the one or more computers, cause the one or more computers to implement:
an action selection neural network configured to generate an action selection output that is used to select an action to be performed by the agent, the action selection neural network comprising:
an encoder sub network configured, at each of a plurality of time steps, to receive an encoder sub network input comprising a current observation characterizing a current state of the environment and to generate an encoded representation of the current observation;
an attention sub network configured, at each of the plurality of time steps, to receive an attention sub network input comprising the encoded representation of the current observation and to generate an attention sub network output at least in part by applying an attention mechanism over the encoded representation of the current observation and encoded representations of one or more previous observations characterizing one or more previous states of the environment;
a recurrent sub network configured, at each of the plurality of time steps, to receive a recurrent sub network input derived from the attention sub network output to update a current hidden state of the recurrent sub network that corresponds to the time step and to generate a recurrent sub network output; and
an action selection sub network configured, at each of the plurality of time steps, to receive an action selection sub network input comprising the recurrent sub network output and to generate the action selection output that is used to select the action to be performed by the agent in response to the current observation.

2. The system of claim 1, wherein the encoded representation of the current observation comprises an input vector having a respective input value at each of a plurality of input positions in an input order.

3. The system of claim 2, wherein the attention sub network comprises a plurality of attention layers each configured to receive an attention layer input for each of a plurality of layer input positions and, for each particular layer input position in a layer input order:
apply the attention mechanism over the attention layer inputs at the layer input positions using one or more queries derived from the attention layer input at the particular layer input position to generate a respective attention layer output for the particular layer input position.

4. The system of claim 3, wherein the attention mechanism is a masked attention mechanism.

5. The system of claim 1, wherein the recurrent sub network comprises one or more long short-term memory (LSTM) layers.

6. The system of claim 1, wherein the action selection output comprises a Q value for each of a possible set of actions that is an estimate of a return that would be received if the agent performed the action in response to the current observation.

7. The system of claim 1, wherein the action selection neural network further comprises a gating layer configured to apply a gating mechanism to i) the encoded representation of the current observation and ii) the attention sub network output to generate the recurrent sub network input.

8. The system of claim 7, wherein applying the gating mechanism to i) the encoded representation of the current observation and ii) the attention sub network output comprises:
applying a gated recurrent unit (GRU) on i) the encoded representation of the current observation and ii) the attention sub network output.

9. The system of claim 1, wherein at each of the plurality of time steps, the attention sub network input comprises the encoded representation of the current observation and the encoded representations of the one or more previous observations characterizing the one or more previous states of the environment.

10. (canceled)

11. (canceled)

12. A method of training an action selection neural network that is configured to generate an action selection output that is used to select an action to be performed by an agent interacting with an environment to perform a task, the method comprising:
processing, using at least an attention sub network of the action selection neural network that has a plurality of attention sub network parameters, a masked input vector that masks the respective input value at each of one or more of the plurality of input positions in the input order to generate a prediction of the respective input value at each of the one or more of the plurality of input positions in the input order;
evaluating a contrastive learning objective function that measures, for each of the one or more of the plurality of input positions in the input order:
a first difference between i) the prediction of the respective input value and ii) the respective input value in the input vector included in the encoded representation of the current observation, and
a second difference between i) the prediction of the respective input value and ii) a respective input value in an input vector included in an encoded representation of an augmented current observation; and
determining, based on a computed gradient of the contrastive learning objective function, an update to current values of the plurality of the attention sub network parameters.

13. The method of claim 12, further comprising generating the masked input vector by:
randomly selecting the one or more of the plurality of input positions in the input order; and
applying a mask to the respective input value at each of the randomly selected one or more of the plurality of input positions in the input order.

14. The method of claim 12, wherein the augmented current observation comprises a future observation characterizing a future state of the environment that is after the current state.

15. The method of claim 12, wherein the augmented current observation comprises a geometrically transformed or color space-transformed current observation.

16. The method of claim 12, further comprising:
processing the current observation using the action selection neural network having a plurality of action selection network parameters to generate the action selection output;
determining, based on the action selection output, a reinforcement learning loss; and
determining, based on the reinforcement learning loss, an update to current values of the action selection network parameters.

17. A computer-implemented method for controlling an agent interacting with an environment to perform a task, the method comprising, at each of a plurality of time steps:
receiving an encoder sub network input comprising a current observation characterizing a current state of the environment;
generating an encoded representation of the current observation;
generating an attention sub network output at least in part by applying an attention mechanism over the encoded representation of the current observation and encoded representations of one or more previous observations characterizing one or more previous states of the environment;
based on a recurrent sub network input derived from the attention sub network output, updating a current hidden state of a recurrent sub network that corresponds to the time step and generating a recurrent sub network output; and
based on an action selection sub network input comprising the recurrent sub network output, generating an action selection output;
selecting an action to be performed by the agent based on the action selection output; and
transmitting to the agent control data instructing the agent to perform the selected action.

18. (canceled)

19. (canceled)

20. The method of claim 17, wherein the encoded representation of the current observation comprises an input vector having a respective input value at each of a plurality of input positions in an input order.

21. The method of claim 17, wherein the attention mechanism is a masked attention mechanism.

22. The method of claim 17, wherein the recurrent sub network comprises one or more long short-term memory (LSTM) layers.

23. The method of claim 17, wherein the action selection output comprises a Q value for each of a possible set of actions that is an estimate of a return that would be received if the agent performed the action in response to the current observation.

24. The method of claim 17, wherein at each of the plurality of time steps, the attention sub network input comprises the encoded representation of the current observation and the encoded representations of the one or more previous observations characterizing the one or more previous states of the environment.
